(19) United States
(12) Patent Application Publication
(10) Pub. No.: US 2015/0105166 A1
(43) Pub. Date: Apr. 16, 2015

(54) Attraction Facility

(71) Applicant: Aram Akopian, Burbank, CA (US)

(72) Inventor: Aram Akopian, Burbank, CA (US)

(21) Appl. No.: 14/053,364

(22) Filed: Oct. 14, 2013

(51) Int. Cl. G07F 17/32

(52) U.S. Cl. CPC G07F 17/32
USPC 472/57

(57) ABSTRACT

The present invention provides a novel type of attraction, where visitors can try out as participants of TV game shows. The attraction consists of a number of different sections, each of the said sections recreating the players' stage of a TV game show. Visitors of the attraction have an opportunity of visiting one after another the said sections and trying out at different game shows recreated there.

### FIELD OF THE INVENTION

The present invention relates to attractions.

### BACKGROUND OF THE INVENTION

Television game shows are very popular with public. Most people like watching them and would love to try out as participants, but only a few get the chance to do so. The closest most people can get to playing a game of a TV show is to play its board game version (ex, for “Family Feud” and “Who Wants to Be a Millionaire?”), or the computer game version (ex, for “Jeopardy”). Only for the game of “Jeopardy” there is a popular and relatively accessible option of experiencing its play through amateur tournaments organized at various levels, often specifically dedicated to a particular topic.

Further in addition to the above-mentioned inaccessibility to most of the public, many television game shows are discontinued after a number of seasons.

In view of the foregoing, there is therefore a need for a solution to people's extremely-limited opportunity of trying out at games of television game shows.

### SUMMARY OF THE INVENTION

It is the object of the present invention to provide the general public with an easily-accessible possibility to get an imitated experience of television game show participation.

The object of the invention is achieved by means of an attraction facility. The present invention provides a novel type of attraction, where visitors can try out as participants of TV game shows. The attraction consists of a number of different sections, each of the said sections recreating the players' stage of a TV game show. Visitors of the attraction have an opportunity of visiting one after another the said sections and trying out at different game shows recreated there.

Similar to Madame Tussauds, where people enjoy the fantasy of getting close to wax imitations of celebrities, this invention allows them to enjoy getting the opportunity of experiencing a close imitation of a TV game show.

One advantage of the invention is that it spares people of potential public embarrassment on television in case of poor game performance. Playing a game on a private visit to an attraction does not carry the risk of such public embarrassment.

Another advantage of the invention is that it allows enjoying the attraction in multiple places around the world far away from the original studio location.

### BRIEF DESCRIPTION OF FIGURES

FIG. 1. Perspective schematic representation of a two-building attraction facility of the invention according to an embodiment.

FIG. 2. Schematic floor plan of an attraction section of building 1 of FIG. 1.

FIG. 3A-B Schematic floor plans related to the single attraction section of building 2 of FIG. 1.

### DETAILED DESCRIPTION

Throughout this Detailed Description, the terms “attraction” and “attraction section” are used interchangeably.

The attraction facility of this invention comprises multiple sections, each of which provides the recreated stage of a television game show, where the visitors of the attraction facility can try out at an imitation of the said television game show.

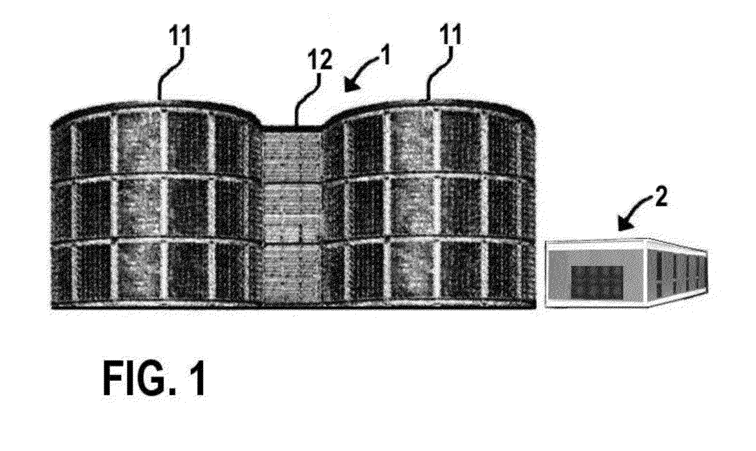

Referring to FIG. 1, it depicts an exemplary preferred embodiment of the invention's attraction facility, whereby the said attraction facility accommodates its game show attractions in two buildings. The TV game show attractions of the said attraction facility are grouped into two separate themes: quiz game shows and physical task game shows. One building houses one group, the second—the other.

In the embodiment of FIG. 1, quiz game show sections are housed in building 1. The building 1 is a three-floor building with two wings 11 linked to each other by a central hall structure 12. Each wing of a floor houses a different game show attraction, with six sections in total housed on three floors of the building.

The central hall 12 of building 1 houses in its center escalators allowing visitors access to all three floors of the building. The hall's floor space around the escalators on the three levels is occupied by food kiosks and restaurants, gift shops, ATMs and restrooms.

In the invention's exemplary embodiment, the quiz game stages' preferred allocation in the building 1 as described above, one to a wing of a floor, allows visitors to freely choose the order of games being visited, but with a ticketing system to disallow entry into the same section more than once.

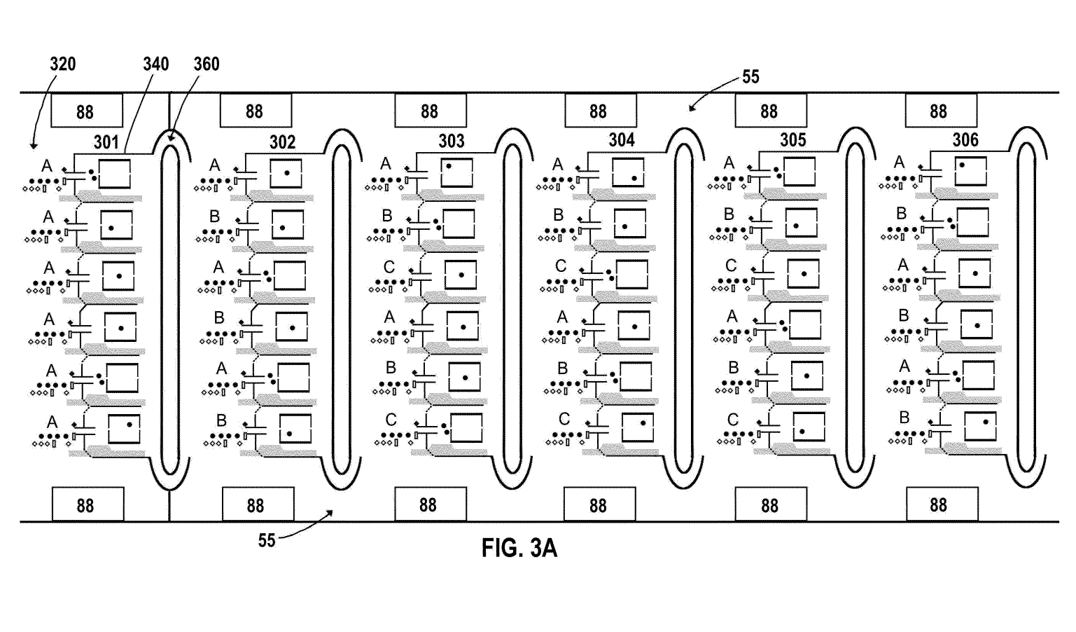

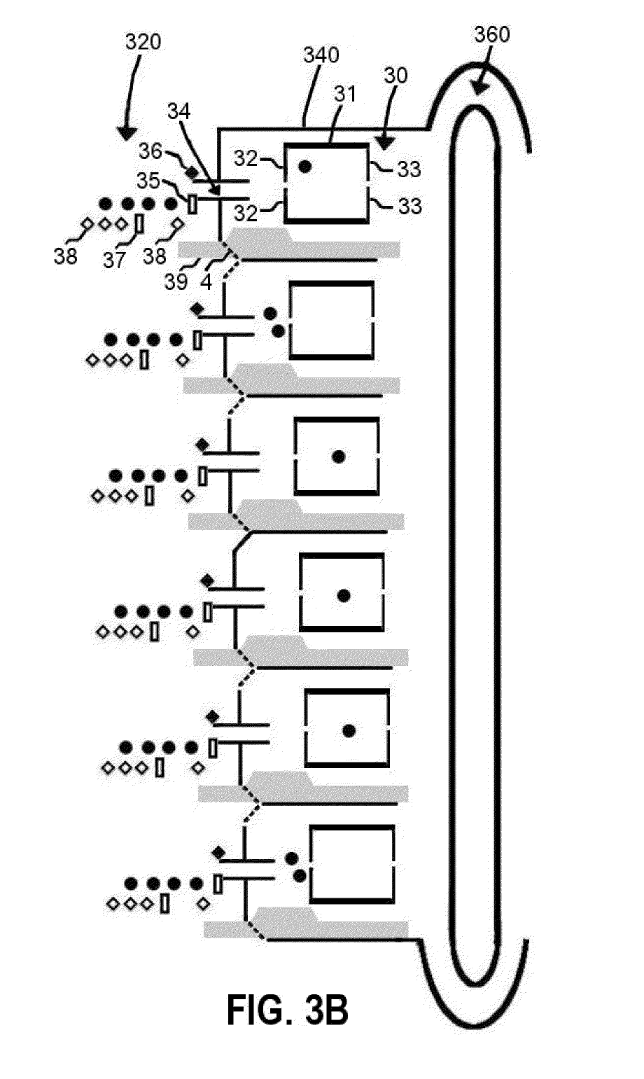

The exemplary embodiment's physical task game section is housed in the one-floor building 2 of FIG. 1. Except for a small entrance foyer, the whole of the building is occupied by a single attraction section detailed further below in FIG. 3.

In order to transform from a television studio set to an attraction provided in a section of the attraction facility, the following adjustments are implemented:

1) Space Adjustment:

The player's stage area is recreated exactly as in the corresponding TV show. In contrast to this, presence of live audience, even if it is incorporated in the original game show, is preferably excluded in the attraction. An exception for presence of live audience is made when, for instance, its participation is required for the game, ex. in the game “Who Wants to Be a Millionaire?”, where the player has an option of a hint from audience. A second exception to the preferred exclusion of audience from the attraction is made in case of physical task games, where family members or friends accompanying the player may watch their playing performance in the said attraction.

In one embodiment, no audience at all is provided in the attraction.

In an alternative embodiment, a game's audience is recreated by means of virtual holographic projections of people. The technology, already used to provide virtual assistants in airports, is well-known to those skilled in the art, and will not be detailed here. Used in the present invention, the above-mentioned virtual audience, remote-controlled by the attraction's host-role employee, responds to a visiting player's performance with positive or negative feedback in the form of applause or gasp sound respectively.

In another embodiment, a game's audience comprises a mix of live audience, made up from attraction's visitors, and virtual holographic projections of people.

In yet another embodiment, audience is made up exclusively of a small group of family or friends accompanying the player.

In case of attraction sections of quiz games without live audience, each such said attraction section includes a “green room” backstage space. This waiting lounge space is where visitors whose turn is next to play in the attraction's game come into from the line outside and wait for the end of the preceding party's play before entering stage. It is similar to “green rooms” of some night talk shows on television, where celebrity guests wait for their turn to appear on stage, for example the green room lounge of the comedy talk show Friday Night with Jonathan Ross.

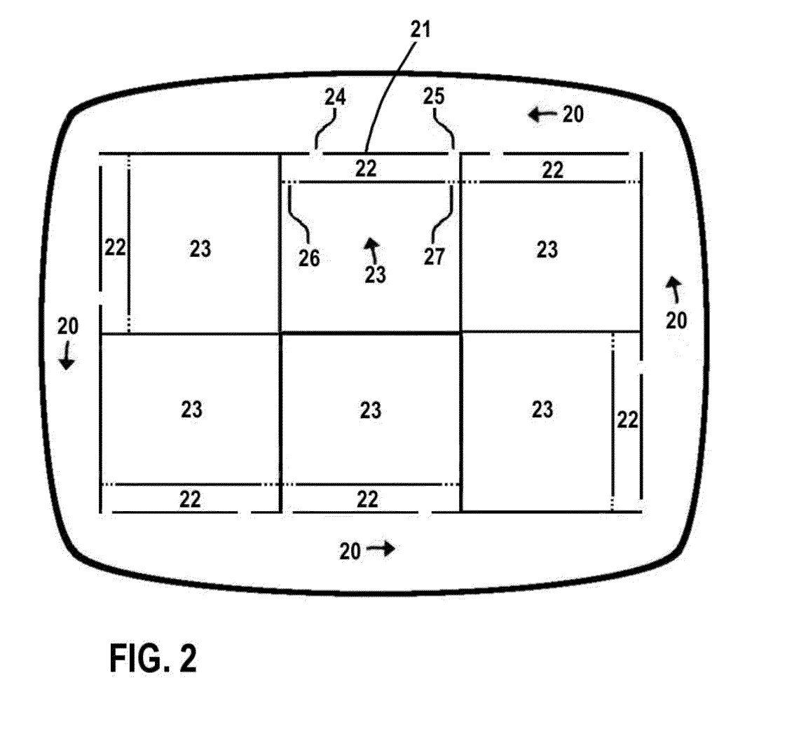

Referring to FIG. 2, it depicts the floor plan of an attraction section of the building 1 of FIG. 1 according to an embodiment. As descried earlier above, the said one attraction section occupies the space of a floor's one wing. Except for the passageway 20 comprising the visitors' queuing space, all of the wing's space is occupied by six identical play areas 21 of the said attraction section. Each of the partitioned play areas 21 has a recreated stage room 23, where visitors can try out at the game, and a green room 22 described earlier. Visitors enter the green room through doorless entrance 24 and come out, after having played the attraction's game, through doorless exit 25. The stage room 23 is accessed from green room 22 through doored entrance 26, and vice versa through doored exit 27.

2) Game Adjustment:

The playing format is reduced from a television show's full length multi-round game to a shortened attraction-fitting imitation of the original.

In case of quiz games, an imitation game is reduced to no more than two rounds.

In one embodiment, a single round of a quiz game show is played.

In an alternative embodiment, two rounds of a quiz game show are played.

In case of quiz games with more than three competing players involved, preferably two rounds of the game are played. First, a single round of the game is played till two players remain. Then, in the second round, a final is played out between the remaining two players.

In case of physical task games, in the preferred embodiment's imitation game, unlike on the original TV show, the visitors get to play the game's multiple rounds whether or not they win each of the said rounds. The number of rounds can be the same as on the show, or different, preferably less.

In the preferred embodiment of the invention, a round is played as originally on the show, or with omission of an option. For example, in the invention's embodiment of “Who Wants to Be a Millionaire?” game, the “phone-a-friend” option is omitted. In another example, in the embodiment of “Million Dollar Money Drop” game the question given to visitors has four answer choices, but with an omitted option the players have possibility of placing money only on two out of four answer choices. In yet another example, in the embodiment of “Wheel of Fortune” game the option of Special Tags placed on the spinning wheel is omitted. Finally, in one more example, in the invention's embodiment of the game show “The Cube”, the option of “trial run” is omitted.

The TV game shows are adapted to the attraction format of the present invention after acquiring the licenses from the corresponding TV show rights owners.

The stage areas of the attraction sections of the present invention are equipped with video camera equipment, allowing recording of visitors' performance and post-game offers to each visitor to buy their game's video recording as a souvenir. This is similar to the common practice of post-attraction sale offers of visitors' photographs made during their experience inside, as done in many well-known existing attractions.

In the invention's preferred embodiment, the visitors who are allowed to play in the attraction facility must be 18 years old or over. Family or friends under 18 accompanying such visitor can wait for them in the attractions' green rooms, or watch them play when an attraction provides for presence of live audience.

In an alternative embodiment, in case of game shows involving playing families made up of two or more generations, visitors of 14 years age or over are also allowed to play along with their older family members.

Although in quiz game attractions' most embodiments only players who are 18 years old or over are allowed to play, nevertheless, preferably only quiz questions approved for all audiences, i.e. excluding adult themes, are used in the attraction facility of the present invention. Despite absence of live audience in most such embodiments, as described above, and hosting of players' accompanying family members in a separate green room during the game, such question filtering is still preferred because younger family members might want to watch at home the said players' performance video recording if bought after the game.

The invention's arrangements regarding audience and separate green room waiting space before one's turn to play in a quiz game attraction allow recycling of questions for new visitors playing on stage of the said attraction, preferably throughout a day.

In the invention's preferred embodiment, visitors benefit from a point system for winning in games of the attraction facility where the victory of the game is achieved by an individual player, or a team of no more than two players. A single point is awarded to a player for winning in every such game, and the player wins a prize if scoring maximal points by winning in all point-system games of the attraction facility.

In addition to the said point-system prize, a player may also win a separate prize attached to an individual attraction, for example by establishing a new time record for the game's victory.

In the exemplary preferred embodiment, there are seven attraction sections as follows.

The building 1 of FIG. 1 houses six quiz game attractions:

1)“Pyramid”:

The attraction's imitation game consists of “The $25,000 Pyramid” television game show's one-minute long single round called “The Winner's Circle”.

In addition to a stage room, each partition of the attraction section has also a green room lounge as per FIG. 2, where every visitor whose turn is next to play the game waits for the end of the preceding visitor's play before entering stage.

The attraction's game can be played by visitors who are 18 years old or over. Under 18 year-olds accompanying a player wait for them in the green room.

In addition to a host, each stage of the attraction section has also an employee to act as the visitor's playing partner for the game.

The attraction game is played in front of an audience created by means of virtual holographic projections of people.

A victory in the game awards the player a point towards a prize given to everyone who wins in all point-system quiz games of the attraction facility.

In addition, a player can also win a separate prize attached to this attraction, by beating the currently-held time record for the game's victory.

2) “Weakest Link”:

The attraction's imitation game consists of two rounds. First, the complete set of contestants play a single round of “Weakest Link” television game show, with the option of “banking” omitted and player elimination in case of a wrong answer or pass. The said first round is played until all but three players get eliminated through wrong answers or passes, the three remaining players vote one out, and a second “head-to-head” round is played out between the two finalists.

In addition to a stage room, each partition of the attraction section has also a green room lounge as per FIG. 2, where visitors from the front of the line wait for the end of the preceding visitors' play before entering stage.

The attraction's game can be played by visitors who are 18 years old or over. Under 18 year-olds accompanying the players wait for them in the green room.

No audience is provided in the attraction, neither live nor virtual.

A victory in the game awards the player a point towards a prize given to everyone who wins in all point-system quiz games of the attraction facility.

3) “Family Feud”:

The attraction's imitation game consists of two rounds of “Family Feud” television game show. First, the show's round called “Fast Money” is played by every visitor entering stage from the green room. After playing it, they can either choose one of the two opposing teams to join, or, if the team of their choice is already complete, simply join the other team. Everyone's scores for the round are revealed only after both teams of five players become completed. The attraction's host designates the person with the highest score in each team as the team's captain. A second round is then played out between the two teams thus formed, whereby the captains face-off to decide which team gains control of the question. The said second round is played out as a main game round of the television show, and the attraction game's victory is awarded to one of the teams after adding up both rounds' scores.

In addition to a stage room, each partition of the attraction section has also a green room lounge as per FIG. 2, where ten first visitors from the front of the line wait for the end of the preceding visitors' play before entering stage.

The attraction's game can be played by visitors who are 14 years old or over. Others below that age are still allowed to stand alongside their older family members on stage during the game.

The imitation game is played in front of an audience created by means of virtual holographic projections of people.

4) “Million Dollar Money Drop”:

The attraction's imitation game consists of a single round of “Million Dollar Money Drop” television game show, with an omitted option. The question given to players has four answer choices, but with an omitted option they can place money only on up to two of the answer choices.

In addition to a stage room, each partition of the attraction section has also a green room lounge as per FIG. 2, where everyone whose turn is next to play the game waits for the end of their predecessors' play before entering stage.

The attraction's game can be played only by visitor couples who are 18 years old or over. Under 18 year-olds accompanying such a couple can join them in the stage room during the game.

No audience is provided in the attraction, neither live nor virtual.

Each person of the playing couple earns a point towards the prize of the point-system quiz games of the attraction facility in case of victory in the “Million Dollar Money Drop” attraction without any money loss.

The money used in the attraction is preferably fake.

5) “Wheel of Fortune”:

The attraction's imitation game consists of a single “Speed-Up” round of “Wheel of Fortune” television game show, with the option of special tags placed on the wheel (Wild Card tag, Gift tag and ½ Car tags) omitted. The order of players' participation in the said round is determined by everyone of three players spinning the wheel and comparing the values struck. To further maximize everyone's chance to be able to provide at least one guess during the game, following their wheel spin the players also have a chance to call one letter, except if the wheel hits an unlucky wedge (“Bankrupt” or “Lose a Turn”).

In addition to a stage room, each partition of the attraction section has also a green room lounge as per FIG. 2, where visitors from the front of the line wait for the end of the preceding visitors' play before entering stage.

The attraction's game can be played by visitors who are 18 years old or over. The playing party can be an individual, or a couple, both types being admissible in the same game. Under 18 year-olds accompanying players can join them in the stage room during the game.

The attraction game is played in front of an audience created by means of virtual holographic projections of people.

A victory in the game awards the playing party (to each in case of a couple) a point towards a prize given to everyone who wins in all point-system quiz games of the attraction facility.

6) “Who Wants to be a Millionaire?”:

Each partition of the attraction section contains only a stage room, and no green room. While waiting for their turn in the chair, the visitors are seated in the stage room's audience amphitheatre, which, unlike on television show, is isolated from the host-and-player stage area by a soundproof glass barrier. The audience thus cannot hear what question is being asked, and learn about it only when “Ask the Audience” help option is used by a player.

The attraction's imitation game consists of a single question not answered by the previous player, or next value question if answered by the previous player. If previous player requested audience help, but did not answer the question correctly, the next player does not get the same question, but gets a question of the same value.

The attraction's game can be played by visitors who are 18 years old or over. Under 18 year-olds accompanying a player can follow them to the other side of the glass barrier and watch their performance up-close from specially provided next-to-stage seats.

The game's audience comprises a mix of live audience, made up from attraction's visitors, and virtual holographic projections of people. The real part of audience can help a player through the “Ask the Audience” option.

Both “50/50” and “Ask the Audience” options are available in the imitation game, while the “Phone-a-friend” option is omitted. Using “Ask the Audience” option is discouraged, as a player then is not entitled anymore to get the game's video recording as a souvenir.

A victory in the game awards the player a point towards a prize given to everyone who wins in all point-system quiz games of the attraction facility.

The building 2 of FIG. 1 houses a single attraction called “Cube”.

7) “Cube”:

The attraction's imitation game consists of physical tasks played on “The Cube” television game show.

Six tasks are played in the attraction instead of seven played on the television show. Unlike players on television show, attraction visitors can play all six tasks independently of whether they win or lose any of them.

In the preferred embodiment, the tasks of the attraction are selected from among the tasks of the TV game show upon satisfaction of the following criteria. Firstly, a task must be a particularly interesting one because of being a task that is not easy to execute and practice at home. Preferably, one that requires sophisticated requisite (props), similar to many triable exhibits in science expos. Secondly, the task must be one that creates the least of mess during play, and is fast to be prepared for the next player after the play of the previous visitor. Thirdly, the task must allow for constraining by a time limit (either be already time-constrained in the original TV show, or be easily time-constrainable for the attraction version). And finally, determination of the task's successful or failed executions must be possible automatically (either already automated in the original TV show, or easily automatable for the attraction version using detector accessories well-known to those skilled in the art).

The tasks of the exemplary preferred embodiment are listed below. Six different types of tasks are provided, each given a descriptive name. The types of tasks in the said embodiment are called “Reaction Speed game”, “Target game”, “Floor game”, “Precision game”, “Tough Ball game” and “Final Challenge game”. In the attraction embodiments, all but the first task type include multiple alternatives. All alternative tasks for each task type are labeled for differentiation by letters A, B, or C. The said alternative tasks are listed by their television game show names, followed by the task's description.

1) “Reaction Speed Game”:

A—Chase: A large round console is located in the center of the Cube, with nine buttons on its surface. Any button can light up at random, and the player must quickly extinguish the light by pressing that button. When one is extinguished another button lights up. The game is won if the player is fast enough to be able to extinguish twenty lights in ten seconds.

2) “Target Game”:

A—Revolution: Standing on a rotating podium, the player must throw a ball inside a target container placed in the opposite corner of The Cube.

B—Void: The player must roll a large red disc from one corner of The Cube to the other so that at the end it passes through a target gap between two vertical surfaces.

3) “Floor Game”:

A—Pursuit: The contestant stands in the center of The Cube. Around are eight red squares, One of them turns blue, then red again. The eight squares then travel around the floor of The Cube at speed. The contestant must try to visually follow among others the red square that had turned blue, and step on it when they stop.

B—Calculate: A number of red squares flashes on the floor of The Cube row by row in a wave-like pattern. Ten rows of squares flash in total through two waves. The player must add up the number of squares that flashed and give the correct answer.

C—Axis: A red horizontal and a blue vertical bars spread at a fast speed across the floor of the Cube, and using each of two buttons of the corresponding color the player must stop both of them inside their target zones on the floor of the Cube.

4) “Precision Game”:

A—Composure: The player must guide a ring around an upright circular hoop without the two coming into contact.

B—Pinpoint: The player must thread a metal rod through a series of three rings so that it reaches the target panel behind them, without the rod touching any of the rings.

C—Side-track: The player must guide a metal rod between two sets of parallel bars without letting the rod touch the bars. On one side the bars are ascending, while on the opposite side the bars are descending.

5) “Tough Ball Game”:

A—Pendulum: The player must swing a small metallic ball on an arc around a column in the center of the Cube so that at the end of the flight it knocks another small metallic target ball off its stand.

B—Arc: On a large sloping surface, the contestant must roll a ball from the start zone in one corner into a triangular shaped target area in the opposite corner. In the centre is a large barrier. The ball must be thrown in an arc to traverse this barrier and make it into the target area. Angle and the power of throw must be judged carefully as the surface has no edges.

C—Circumference:

The player must roll a ball around a circular track. The ball must make a full circle around the track and stop rolling in the same target zone from where it started.

6) “Final Challenge Game”:

A—Elevation: The player must elevate a clear horizontal tube using ropes on either side of it without letting the red ball inside the tube drop out of either end of the tube, until the tube reaches target containers located high above on tube's both sides. To win, the player must deposit the ball into one of them.

B—Navigate: The player must put on a blindfolded helmet and walk over a border-limited path from one corner of The Cube to the opposite corner, navigating around four upright poles present along the path. The player must both stay inside the borders of the path and not touch the poles on the way.

Referring to FIG. 3 A-B, a schematic floor plan of the attraction section of TV game show “The Cube” in building 2 of FIG. 1, along with an enlarged segment of it, is shown.

FIG. 3A depicts the schematic floor plan of the whole attraction section.

There are six consecutive play areas for a visitor to pass through in the attraction, labeled in the figure as 301 to 306.

Each play area allows a visitor to try out at one of the alternatives (A, B, or C) of one of the six different task types listed earlier, in the corresponding order: 301 area for “Reaction Speed game” task, 302 area for “Target game” tasks, 303 area for “Floor game” tasks, 304 area for “Precision game” tasks, 305 area for “Tough Ball game” tasks and 306 area for “Final Challenge game” tasks.

Each said play area comprises a queuing area 320, a stage room area 340 and an exit corridor 360.

While outside of a stage room area, visitors may use restrooms 88 available in every play area of the attraction section.

The space around restrooms 88 starting from the second play area (play area 302) and onwards forms two passageways 55. These restroom-by passageways allow a visitor not wishing to play all the tasks to be able to skip a play area at any point after the first entry game of play area 301.

In order to recreate for visitors the characteristic lighting pattern employed in the television game show, the attraction section is scarcely lit up, only by dim lights on the walls of passageways 55, and in play areas, as detailed in FIG. 3B.

FIG. 3B depicts an enlarged view of a play area of FIG. 3A for detailed description, through the example of play area 303.

The stage room area 340 of the play area comprises a sequence of six stage rooms 30 lined up in parallel back-to-back. Each stage room 30 contains a standard-size transparent Perspex cube 31 similar to the one on the television show. The cube has glass doors 32 and 33 on two opposite sides, for entry and exit of the player.

For undisturbed playing experience, each stage room is isolated by a wall depicted on the figure with a solid line. The wall is 1 ft (0.3 meters) higher than the height of the Perspex cube. The dotted lines breaking on the figure the said solid line represent access doors 4 to the stage rooms for their host employees of the attraction facility.

Black dots in the FIG. 3B represent humans. A black dot inside a cube represents a visitor playing a task of the play area. Two black dots inside a stage room represent its host greeting a visitor walking into the stage room prior to letting them enter the cube. Black dots in the queuing area 320 represent lines of visitors prior to entry into a stage room through an entry corridor 34.

At the entrance to a play area visitors have the option of standing in any one of the lines present there, each said line leading to a stage room of a particular task alternative (A, B, or C) of the play area's tasks. Preferably, visitors are not informed in advance which line leads to which task, and learn about their stage room's task just before entering it.

There is a screen 35 and a signal light 36 by the entrance to a stage room. A sign 37 beside every line tells visitors to press the button on screen 35 when in front of it for explanation of the cube's task, and wait for the signal light to turn green in order to walk into the stage room. Upon pressing the said screen's button, a video demonstration of the task like that by “The Body” on the television show is shown to the visitor in front of it. The signal light 36 is remote-controlled by the stage room's host employee.

To imitate the television show's lighting pattern, the space lit the brightest in a play area is the cube. The other lights used are ordinary-brightness lamp posts 38 along lines in the queuing area (represented in the figure by white diamond shapes), dim lights in the entry corridor 34, dim floor lighting in the stage room, dim lighting of the platform 39 described further below, and ordinary-brightness wall lighting in the exit corridor 360.

The Cube lights up whenever a stage room's host opens with a button its entry doors 32 to let a visitor play out the task inside of it during a limited period of time. The exit doors 33 open automatically at the end of the task.

The end of a task is determined by signals from detectors or input devices used in it, or by the cube's timer in case of no such signals, when the task has simply not been completed within its allocated time.

The victory and failure outcomes of a player's performance in the task are accompanied by the cube lighting up into green or red respectively, similar to what happens in the television show.

Having let a visitor into a cube, the host employee uses the doors 4 to go into two nextdoor stage rooms, in each of them making sure that the cube's task props are ready for the next player, and then getting the said next player into the cube—before returning to do the same in the stage room mentioned first.

The attraction's physical tasks can be played by visitors who are 18 years old or over. Under 18 year-olds accompanying such a player stand alongside them in a queuing line, and then go up onto a raised platform walkway 39 to watch the player's performance from there. The said raised platform walkway 39, present by each stage room, is shown on the floor plan as colored in gray. It has a height slightly over the height of the stage room walls, allowing it to go over the wall and protrude into the stage room. This in turn allows people standing on it to observe the player inside the cube. The raised platform walkway has stairs at both ends.

Except for the small group of family or friends accompanying a player, there is no other audience in the attraction embodiment of “The Cube” game.

Both the players and everyone accompanying them exit the play area through the exit corridor 360.

The only difference between the play area described above in FIG. 3B and other play areas of the attraction section of FIG. 3A are the tasks presented to visitors for execution in the Perspex cube.

In an alternative to the present invention's exemplary preferred embodiment described in detail above, all game show attractions may be located in one same building.

In other alternative embodiments, another set of game shows may be adapted to constitute the attraction facility of the present invention.

The hosts of attraction game stages of the present invention are preferably people with appearance similarities to the hosts of the corresponding TV shows.

Other common aspects of reception and hosting of visitors in the attraction facility are done in a manner similar to the one at indoor attractions of theme parks, ex. Universal Studios or Disneyland. This is well-known to those skilled in the art and will not be unnecessarily detailed here.

Although the invention has been described in detail herein, it is not limited to the embodiments herein disclosed. Various changes and modifications may be made thereto by those skilled in the art without departing from the spirit or scope of the invention.

It is therefore understood that the invention is to be limited only as specified in the appended claims.

1. An attraction facility comprising a plurality of sections, each of the said sections recreating the players' stage of a television game show, whereby the visitors of the said attraction facility can enter the recreated stages and try themselves out as participants of imitations of the said television game shows.

2. An attraction facility in accordance with claim 1, wherein the players' stage of a television game show is recreated and exploited in an attraction section in multiple copies.

3. An attraction facility in accordance with claim 1, wherein all the recreated stages of television game shows are located in the same building.

4. An attraction facility in accordance with claim 2, wherein all the recreated stages of television game shows are located in the same building.

5. An attraction facility in accordance with claim 1, wherein the recreated stages of television game shows are located in more than one building.

6. An attraction facility in accordance with claim 2, wherein the recreated stages of television game shows are located in more than one building.

7. An attraction facility recreating the players' stage of a single television game show, whereby the players' stage of the said television game show is recreated and exploited in the said attraction facility in multiple copies and whereby the visitors of the said attraction facility can enter the recreated stages and try themselves out as participants of an imitation of the said television game show.
